(19) United States
(12) Patent Application Publication
(10) Pub. No.: US 2026/0161998 A1
(43) Pub. Date: Jun. 11, 2026

(54) QUANTIZATION ROBUST FEDERATED MACHINE LEARNING

(71) Applicant: QUALCOMM Incorporated, San Diego, CA (US)

(72) Inventors: Kartik GUPTA, Canberra (AU); Marios FOURNARAKIS, London (GB); Matthias REISSER, Mountain View, CA (US); Christos LOUIZOS, Amsterdam (NL); Markus NAGEL, Amsterdam (NL)

(21) Appl. No.: 18/708,057

(22) PCT Filed: Jan. 4, 2023
(86) PCT No.: PCT/US2023/060103

§ 371 Date: May 7, 2024

(30) Foreign Application Priority Data
Jan. 28, 2022 (GR) 20220100083

(51) Int. Cl. G06N 20/00

(52) U.S. Cl. CPC G06N 20/00

(57) ABSTRACT

Aspects described herein provide techniques for performing quantization robust federated learning of a machine learning model, comprising: receiving a model from a federated learning server; training the model using a local objective function, wherein the local objective function includes a modification configured to increase quantization robustness at a client device; and transmitting to the federated learning server an updated model.

### CROSS-REFERENCE TO RELATED APPLICATIONS

This application claims priority to Greek Patent Application No. 20220100083, filed Jan. 28, 2022, which is assigned to the assignee hereof and hereby expressly incorporated by reference in its entirety as if fully set forth below and for all applicable purposes.

### INTRODUCTION

Aspects of the present disclosure relate to quantization robust federated machine learning.

Machine learning is generally the process of producing a trained model (e.g., an artificial neural network, a tree, or other structures), which represents a generalized fit to a set of training data. Applying the trained model to new data produces inferences, which may be used to gain insights into the new data.

As the use of machine learning has proliferated in various technical domains for what are sometimes referred to as artificial intelligence tasks, more efficient processing of machine learning model data has become more important. For example, “edge processing” devices, such as mobile devices, always-on devices, internet of things (IoT) devices, and the like, have to balance the implementation of advanced machine learning capabilities with various interrelated design constraints, such as packaging size, native compute capabilities, power storage and use, data communication capabilities and costs, memory size, heat dissipation, and the like.

Federated learning is a distributed machine learning paradigm to learn machine learning models from decentralized data that remains on device. Generally, a central server coordinates the federated learning process, and each participating client communicates only model parameter information with the central server while keeping its local data private. This distributed approach mitigates data privacy concerns in many cases.

Even though federated learning generally limits the amount of model data in any single transmission between server and client (or vice versa), the iterative nature of federated learning may still generate a significant amount of data transmission traffic during training, which may be costly depending on device and connection types. While local updating methods may reduce the total number of communication rounds, model compression schemes such as sparsification, subsampling, and quantization may significantly reduce the size of messages communicated at each round. However, the messages may be susceptible to interference and quantization noise.

The energy demands and hardware-design induced constraints for on-device learning have remained a challenge. Specifically, an essential demand for on-device learning is to enable trained models to be quantized to various bit-widths on-the-go based on the energy needs and heterogeneous hardware designs across the federated clients.

### BRIEF SUMMARY

Certain aspects provide a method for performing federated learning of a machine learning model at a client device, comprising: receiving a model from a federated learning server; training the model using a local objective function, wherein the local objective function includes a modification configured to increase quantization robustness at a client device; and transmitting to the federated learning server an updated model.

Further aspects provide a method for performing federated learning of a machine learning model, comprising: receiving, at federated learning server from a client device, model update data, wherein the model update data is based on a local objective function used by the client device and including a modification configured to increase quantization robustness at the client device; and updating, by the federated learning server, a global model, based on the model update data.

The following description and the related drawings set forth in detail certain illustrative features of one or more aspects.

### BRIEF DESCRIPTION OF THE DRAWINGS

The appended figures depict certain aspects of the one or more aspects and are therefore not to be considered limiting of the scope of this disclosure.

FIG. 1 depicts an example training flow for quantization robust federated learning.

FIG. 2 depicts an example method for performing quantization robust federated machine learning.

FIG. 3 depicts another example method for performing quantization robust federated machine learning.

FIG. 4 depicts an example algorithm for performing federated averaging with kurtosis regularization.

FIG. 5 depicts an example algorithm for performing federated averaging with optional additive pseudo-quantization noise, quantization-aware training, and multi-bit quantization-aware training steps.

FIG. 6 depicts an example processing system that may be configured to perform aspects of the federated machine learning methods described herein.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for quantization robust federated machine learning.

As machine learning models become more complex and thus larger, it is becoming increasingly difficult to train them on anything but high-power computers, such as servers. Federated learning is a distributed machine learning framework that enables a number of clients, including lower-powered devices, such as edge processing devices, to train a shared global model collaboratively. In such a setting, it is generally desirable to reduce the client device computation along with overall communication costs. In particular, high communication costs might make federated learning through mobile data less practical. One method that may significantly reduce the size of messages communicated at each round is quantization of model data (e.g., weights and biases). However, quantization noise in the quantized messages remains a challenge. Quantization robust federated learning helps to learn a model that may be quantized to different bit-widths without significant degradation of model performance when inferencing in each of those bit-widths.

Integration of multiple quantization robustness methods, such as (but not limited to) Kurtosis Regularization (KURE) and Additive Pseudo-Quantization Noise (APQN), into federated learning helps to achieve quantization robust models that may be used for efficient inference at multiple bit-widths. In addition, as the standard form of Quantization-Aware Training (QAT) integration into Federated Learning fails to generalize across multiple bit-widths, a new technique called Multi-bit Quantization-Aware Training (MQAT) is described herein to achieve quantization robust models learnt in decentralized training setup.

Aspects described herein provide significant advantages compared to existing approaches. For example, the techniques proposed herein may yield models that are robust to quantization at multiple bit-widths despite being learnt in federation. Further, utilization of the techniques disclosed herein may provide these advantages without significant trade-off of the model's full-precision accuracy. The ability to maintain model performance at smaller quantized bit widths means that fewer resources are expended during training (e.g., communications resources) and inferencing (e.g., compute resources).

### Example Training Flow for Quantization Robust Federated Learning

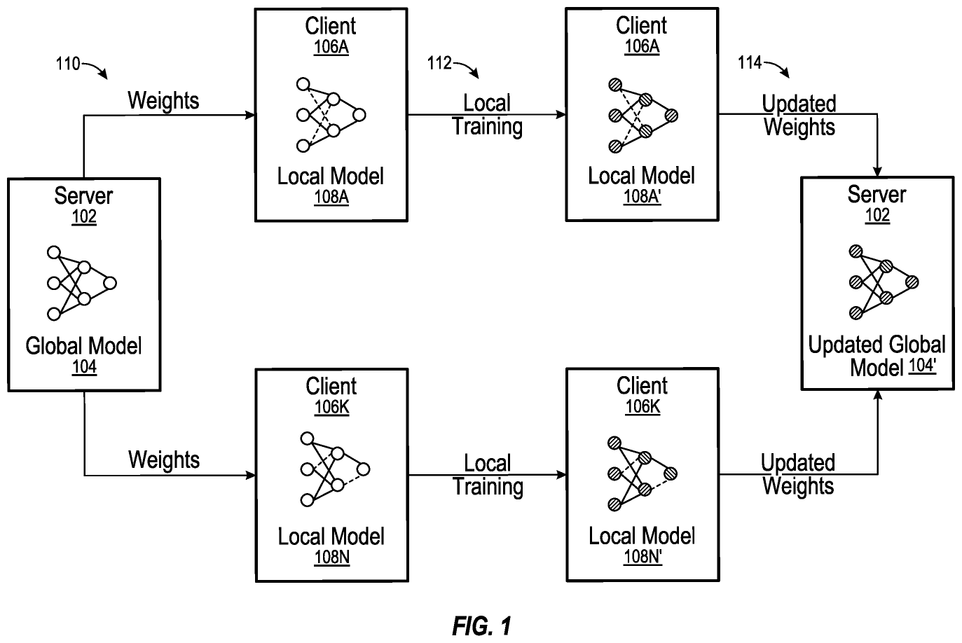

FIG. 1 depicts an example training flow for quantization robust federated learning. The example training flow may be performed using, for example, the Federated Averaging (FEDAVG) algorithm, which operates via series of rounds where each round is divided into a client update phase and a server update phase.

Initially, a server 102 generates or maintains a global model 104 in a first state. In this example, the global model 104 is associated with w representing parameters (e.g., model weights and biases) for the global model.

At 110, at the beginning of round t, the server 102 shares with (e.g., broadcasts to) clients 106A-N global model parameters wₜ, where each client 106A-N may represent a client device (e.g., a smartphone, a laptop or a tablet) participating in federated learning with the server 102. In some aspects, round t ranges from 0 to T−1, where T represents the total number of rounds.

In some aspects, the clients 106A-N are called the set S of sampled clients sampled from the pool of all clients, where N is the number of sampled clients participating in the federated learning. An arbitrary client i may be any one of the clients 106A-N. For simplicity, the discussion below assumes that each of the clients 106A-N is equivalent to client i, and client i is interchangeable with each client 106A-N. Furthermore, parameters below subscripted or superscripted with i may be interpreted as parameters generated by or used at each client 106A-N.

Based on this information, client i generates a local machine learning model 108A-N with parameter

$${w}_{t , k}^{i}$$

based on the parameter received from the server 102, where k specifies the current index of the training step during local machine learning model training. In some aspects, the number of iterations k ranges from 0 to K−1, where K represent the total number of training steps for a client. Further,

$${w}_{t , 0}^{i}$$

represents the initial parameter from the server 102 to client i and thus

$${w}_{t , 0}^{i} = {w}_{t} .$$

At 112, also known as the client update phase, each client 106A-N trains its local machine learning model 108A-N respectively. Generally, each client 106A-N utilizes only private local data, which is not shared with other participants in the federation, such as other clients or server 102. Each client 106A-N generates an updated local machine learning model 108A′-N′, whereas

$${w}_{t , K}^{i}$$

represents the parameter at a local machine learning model 108A′-N′ at the end of a round t.

The local data often varies, beneficially capturing data heterogeneity across the clients 106A-N. As each client 106A-N trains on different data, each updated local machine learning model 108A′-N′ is likely to be different in its trained parameters, which helps the global model 104 generalize to the shared domain of all clients 106A-N.

During the client update phase, various methods may help introduce quantization robustness in federated learning, particularly within the example FEDAVG framework discussed herein. Generally, in a FEDAVG framework, the local objective function at client i may be formulated as Fᵢ(w, Dᵢ)=E_{ξ˜Di}[fᵢ(w, ξ)], where w represents the parameter for the global model, Dᵢ the local data distribution, and ξ is a sample in the local data distribution Dᵢ.

In the following discussion, for simplicity w, Dᵢ and ξ continue representing respectively, the parameter for the global model, the local data distribution, and a sample in the local data distribution Dᵢ.

In quantization robust federated learning, however, the local objective for quantization robustness at client i may be formulated as the following:

$${F}_{i}^{*} ( w , {D}_{i} ) {=}_{ξ - Di} {\sum }_{b ∈ B} [ {f}_{i} ( Q ( w , b ) , ξ ) ] ,$$

where B is a set of quantization bit-widths to which the model is being trained to be robust. Instead of directly optimizing the above objective, which involves multiple forward-backward passes through same batch of samples for each of the different bit-widths, various techniques for introducing quantization robustness in federated averaging framework are introduced and explained in detail below.

Regularization methods, such as (but not limited to) kurtosis regularization (KURE), to enforce uniform distribution on the weight tensors may be incorporated in the federated averaging framework by modifying the loss function for each client 106A-N as:

$${F}_{i}^{*} ( w , {D}_{i} ) = {E}_{ξ - Di} [ {f}_{i} ( w , ξ ) ] + {L}_{KURE} ( w ) ,$$

where L_{KURE}(w) is the proposed kurtosis regularization term. For an L-layered neural network,

$${L}_{KURE} ( w ) = \frac{1}{L} {\sum }_{i = 1}^{L} {\vert K ( {w}_{i} ) - 1.8 \vert}^{2} ,$$

where

$$K ( w ) = E [ {( \frac{w - μ}{σ} )}^{4} ] ,$$

whereas μ is the mean of w and σ the standard deviation of w. It is thus notable that

$${F}_{i}^{*} ( w , {D}_{i} )$$

is Fᵢ(w, Dᵢ) modified by L_{KURE}(w).

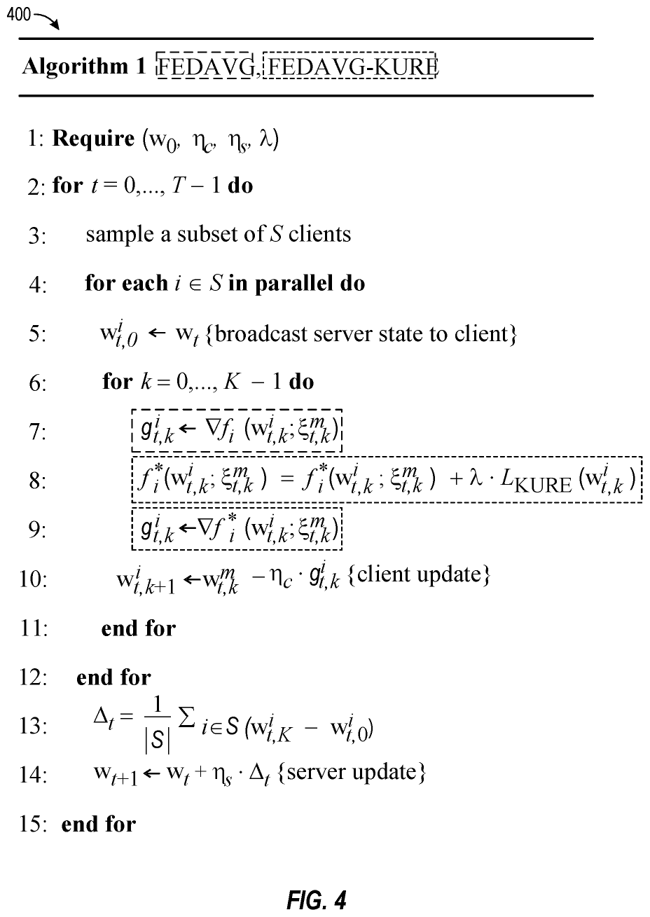

FIG. 4 depicts an example algorithm 400 for performing federated averaging with kurtosis regularization. In particular, lines 8-9 of the algorithm refer to the kurtosis regularization of the conventional federated averaging step of line 7.

Other than regularization-based quantization, robustness schemes may be used to enforce quantization robustness. In order to learn a network robustly, especially with low bit-widths, such schemes may learn the model where the weight parameters or activations are constrained to fixed quantization levels. Although the formulations below explicitly enforce robustness to different bit-widths for weight quantization only, it is likewise possible to enforce the quantization robustness for activations.

### Quantization-Aware Training (QAT) in Federated Learning

A training procedure known as Quantization-Aware Training (QAT) may improve quantization robustness. In one example, a QAT objective may be enforced as a local optimization objective at each client 106A-N to incorporate FEDAVG with QAT. In quantization-aware federated learning, the loss function for each client 106A-N may be formulated as:

$${F}_{i}^{*} ( w , {D}_{i} ) = {E}_{ξ - Di} [ {f}_{i} ( Q ( w , b ) , ξ ) ] ,$$

which is also modified based on Fᵢ(w, Dᵢ). Further, for a b-bit quantizer Q(⋅), a quantization step size Δ_{b} may be defined as:

$$Q ( w , b ) = \{ \begin{matrix}{2}^{b - 1} {Δ}_{b} & w > {2}^{b - 1} {Δ}_{b} \\ {Δ}_{b} \cdot ⌊ \frac{w}{{Δ}_{b}} ⌋ & \vert w \vert \leq {2}^{b - 1} {Δ}_{b} \\ - {2}^{b - 1} {Δ}_{b} & w < - {2}^{b - 1} {Δ}_{b} ,\end{matrix}$$

where └⋅┐ denotes the rounding to nearest integer operation. The quantization step-size Δ_{b} may be either learnt as a parameter or be estimated before the start of training and kept fixed thereafter. Quantizer Q(⋅) quantizes parameter w to the target bit-width b.

A challenge is that quantizer Q(⋅) is not differentiable due to the rounding operation. To overcome this issue, a straight-through estimator (STE) approximation may be performed to estimate a gradient of the rounding operator, which allows updating the local machine learning model during a backward pass.

### Multi-Bit Quantization-Aware Training (MQAT) in Federated Learning

Although QAT in quantization-aware federated learning may train models that perform favorably at trained lower bit-widths, it often results in performance degradation when quantized with other, un-trained bit-widths. To resolve this issue, Multi-bit Quantization-Aware Training (MQAT) may be used to train the models explicitly with different bit-widths. In particular, MQAT aims to learn models robust to different bit-widths belonging to a set B. In MQAT, a bit-width b∈B may be randomly sampled or be pre-determined at the start for each client 106A-N. Then the aforementioned QAT procedure may be followed.

Similar to QAT, the quantization step-size Δ_{b} for different bit-widths may be either learnt as parameter or first estimated before the start of the training and then kept fixed thereafter. The quantization step-size Δ_{b} for different bit-widths may then be shared along the global model 104 with all clients 106A-N.

### Additive Pseudo-Quantization Noise (APQN) in Federated Learning

Another way to improve quantization robustness is to add quantization noise to either the weight tensor (e.g., parameter w) or the intermediate activations. A quantization robustness approach known as Additive Pseudo-Quantization Noise (APQN) involves adding random pseudo-quantization noise during the training procedure.

The aim with APQN is to learn models that are robust to varying level of quantization noise, which may be quantized to different bit-widths. In the FEDAVG framework, the local loss function of quantization robust federated learning at each client 106A-N may be formulated as:

$${F}_{i}^{*} ( w , {D}_{i} ) = {E}_{ξ \sim Di} [ {f}_{i} ( \tilde{Q} ( w , b ) , ξ ) ] .$$

Thus, it can be seen that

$${F}_{i}^{*} ( w , {D}_{i} )$$

is modified Fᵢ(w, Dᵢ). Pseudo-quantizer \tilde{Q}(⋅) with bit-width b adds noise sampled from uniform distribution U[−Δ_{b}/2, Δb/2] may be defined as:

$$\tilde{Q} ( w , b ) = w + U [ - \frac{{Δ}_{b}}{2} , \frac{{Δ}_{b}}{2} ] .$$

Since, the noise may be randomly sampled from the distribution, the trained model may achieve robustness to different bit-widths. The noise may also be sampled from other distributions, such as a Gaussian distribution in one example.

During a client update phase, for example, with round t at training step k of client i, client i may run local Stochastic Gradient Descent (SGD) on its local data based on one of the loss functions (e.g., the loss functions discussed above with KURE, QAT, MQAT, and APQN). In some aspects, during a client update phase, client i may run SGD on its local data based on a combination of the various example loss functions. In some aspects, instead of batch normalization, client i may utilize group normalization during SGD. In some aspects, the client i generates local model parameter

$${w}_{t , K}^{i}$$

that indicates one of local models 108A′-N′ after finishing all training steps during round t.

At 114, known as the server update phase, each client 106A-N transmits model update data back to the server 102. For example, the model update data may include the local model parameter

$${w}_{t , K}^{i}$$

for each client 106A-N. At the end of round t, the server 102 uses the model update data to generate an updated global model 104′. In some aspects, the model update data of the clients 106A-N may be averaged to find a pseudo-anti-gradient, which may be a weighted average of differences between the parameter broadcast by the server 102 and the parameters received from the clients 106A-N. The server 102 then takes an update step to generate the updated global model 104′ based on a server learning rate and the pseudo-anti-gradient.

Notably, FIG. 1 depicts a single round of training for simplicity, and this process may be repeated iteratively any number of times until, for example, a training target is reached (e.g., a number of iterations or steps is complete, the weights converge, an accuracy threshold is reached, etc.).

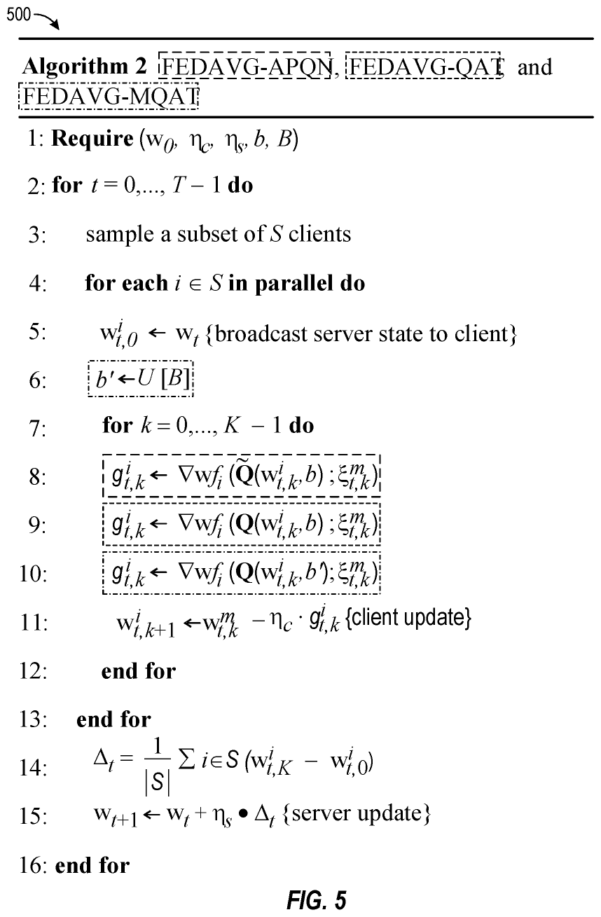

FIG. 5 depicts an example algorithm 500 for performing federated averaging with optional additive pseudo-quantization noise, quantization-aware training, and multi-bit quantization-aware training steps. In particular, line 8 depicts an optional modification of the conventional federated averaging framework for utilizing additive pseudo-quantization noise; line 9 depicts an optional modification of the conventional federated averaging framework for utilizing quantization-aware training; and lines 6 and 10 depict optional modifications of the conventional federated averaging framework for utilizing multi-bit quantization-aware training.

### Example Methods of Performing Federated Learning

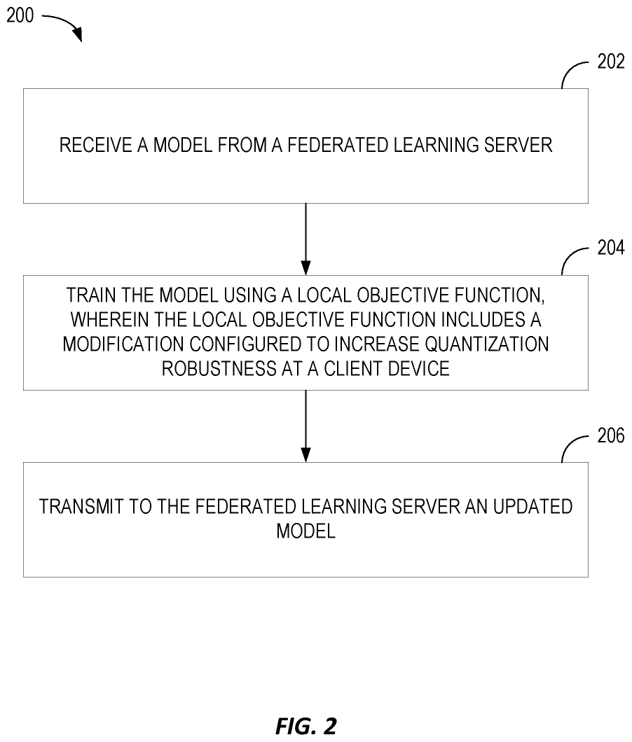

FIG. 2 depicts an example method 200 for performing quantization robust federated learning, which may be performed, for example, by a federated learning client, such as one of clients 106A-N in FIG. 1.

At block 202, the client may receive a model from a federated learning server (e.g., the server 102 in FIG. 1).

Method 200 then proceeds to block 204 with the client training the model using a local objective function. The local objective function may include a modification configured to increase quantization robustness at a client device (e.g., such as described in block 112 with respect to FIG. 1).

Method 200 then proceeds to block 206 with the client transmitting, to the federated learning server, an updated model (e.g., such as described in block 114 with respect to FIG. 1).

In some aspects of method 200, method 200 further comprises: the client optimizing the model for multiple quantization bit-widths without performing multiple forward-backward passes in a training iteration for each of quantization bit-width.

In some aspects of method 200, the modification comprises a quantization regularization term.

In some aspects of method 200, training the model using a local objective function comprises using a kurtosis regularization term.

In some aspects of method 200, the modification comprises a quantizer function configured to quantize weights of the model to a target bit-width.

In some aspects of method 200, training the model using the local objective function comprises estimating a gradient of a quantization rounding operator using straight through estimator approximation.

In some aspects of method 200, the modification comprises a pseudo-quantizer function configured to quantize weights and/or activations of the model to a target bit-width by adding pseudo-quantization noise sampled from a distribution associated with a quantization step-size.

In some aspects of method 200, configuring the quantizer function further comprises: determining a bit-width for training the model at the client device from a set of possible bit-widths used by the federated learning server by sampling from a distribution associated with a quantization step-size.

Notably, FIG. 2 is just one example of a model consistent with the disclosure herein, and further examples are possible, with additional, fewer, and/or alternative steps.

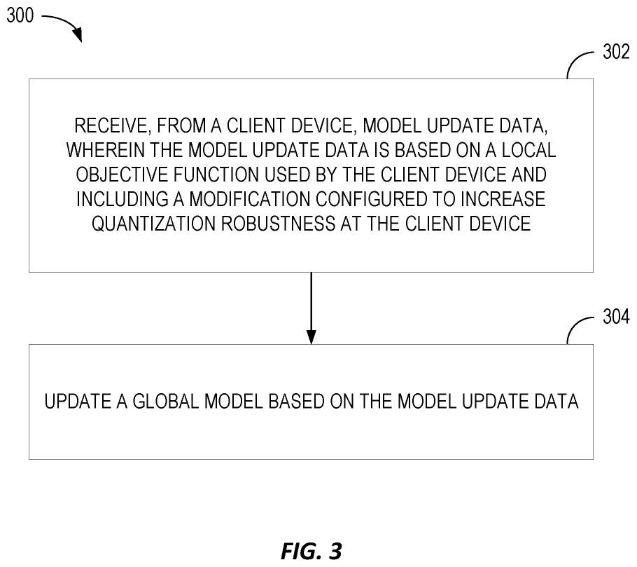

FIG. 3 depicts another example method 300 for performing quantization robust federated learning, which may be performed, for example, by a federated learning server, such as server 102 in FIG. 1.

At block 302 the server may receive from a client device, model update data. The model update data may be based on a local objective function used by the client device and including a modification configured to increase quantization robustness at the client device (e.g., such as described in block 114 with respect to FIG. 1). In various aspects, block 302 may correspond to block 206 of FIG. 2.

Method 300 then proceeds to block 304 with the server updating a global model, based on the model update data (e.g., such as described in block 114 with respect to FIG. 1).

In some aspects, method 300 further comprises sending to the client device a set of bit-widths configured to be randomly sampled during training at the client device.

In some aspects, method 300 may continue with sending the updating global model to the client (e.g., returning to block 202 in FIG. 2).

Notably, FIG. 3 is just one example of a model consistent with the disclosure herein, and further examples are possible, with additional, fewer, and/or additional steps.

### Example Processing System

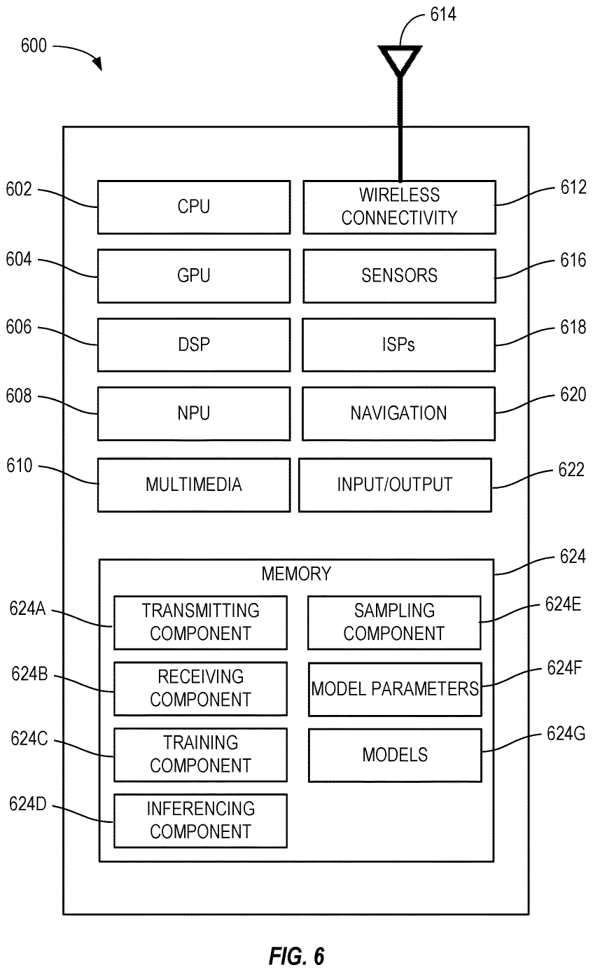

FIG. 6 depicts an example processing system 600 that may be configured to perform aspects of the federated learning methods described herein, including, for example, methods 200 and 300 of FIGS. 2 and 3, respectively, as well as algorithms 400 and 500 of FIGS. 4 and 5, respectively.

Processing system 600 includes a central processing unit (CPU) 602, which in some examples may be a multi-core CPU. Instructions executed at the CPU 602 may be loaded, for example, from a program memory associated with the CPU 602 or may be loaded from a memory 624.

Processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

An NPU, such as 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), or vision processing unit (VPU).

NPUs, such as 608, may be configured to accelerate the performance of common machine learning tasks, such as image classification, sound classification, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 608 is a part of one or more of CPU 602, GPU 604, and/or DSP 606.

In some examples, wireless connectivity component 612 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 612 is further connected to one or more antennas 614.

Processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In this example, memory 624 includes transmitting component 624A, receiving component 624B, training component 624C, inferencing component 624D, sampling component 624E, model parameters 624F (e.g., model parameter such as weights and activations, as discussed above), and models 624G. The depicted components, and others not depicted, may be configured to perform various aspects of the methods described herein.

Processing system 600 is just one example and may generally perform the operations of the server and/or clients/clients described herein. However, in other aspects, certain aspects may be omitted. For example, a server may omit certain features that may be regularly found in a mobile device, such as multimedia component 610, wireless connectivity component 612, antenna 614, sensors 616, ISPs 618, and navigation component 620. The depicted example is not meant to be limiting.

### Example Clauses

Implementation examples are described in the following numbered clauses:

Clause 1: A method for performing federated learning of a machine learning model at a client device, comprising: receiving a model from a federated learning server; training the model using a local objective function, wherein the local objective function includes a modification configured to increase quantization robustness at the client device; and transmitting to the federated learning server an updated model, based on the training.

Clause 2: The method of Clause 1, further comprising optimizing the model for multiple quantization bit-widths without performing multiple forward-backward passes in a training iteration for each of quantization bit-width.

Clause 3: The method of Clause 1, wherein the modification comprises a quantization regularization term.

Clause 4: The method of Clause 3, wherein training the model using the local objective function comprises using a kurtosis regularization term.

Clause 5: The method of any one of Clauses 3-4, wherein the local objective comprises

$${F}_{i}^{*} ( w , {D}_{i} ) = {E}_{ξ \sim Di} [ {f}_{i} ( w , ξ ) ] + {L}_{KURE} ( w ) ,$$

and L_{KURE}(w) is the kurtosis regularization term.

Clause 6: The method of Clause 1, wherein the modification comprises a quantizer function configured to quantize weights of the model to a target bit-width.

Clause 7: The method of Clause 6, wherein training the model using the local objective function comprises estimating a gradient of a quantization rounding operator using straight through estimator approximation.

Clause 8: The method of any one of Clauses 6-7, wherein the local objective comprises

$${F}_{i}^{*} ( w , {D}_{i} ) = {E}_{ξ \sim Di} [ {f}_{i} ( Q ( w , b ) , ξ ) ] .$$

Clause 9: The method of Clause 1, wherein the modification comprises a pseudo-quantizer function configured to quantize weights and/or activations of the model to a target bit-width by adding pseudo-quantization noise sampled from a distribution associated with a quantization step-size.

Clause 10: The method of Clause 9, wherein the distribution is a uniform distribution parametrized in part by a specified bit-width.

Clause 11: The method of Clause 1, further comprising determining a bit-width for training the model at the client device from a set of possible bit-widths used by the federated learning server by sampling from a random distribution associated with a quantization step-size.

Clause 12: The method of Clause 11, wherein the random distribution is a uniform distribution.

Clause 13: The method of any one of Clauses 11-12, further comprising learning a quantization step size during the training.

Clause 14: The method of any one of Clauses 1-13, wherein training the model using the local objective function comprises using stochastic gradient decent.

Clause 15: A method for performing federated learning of a machine learning model, comprising: receiving, at federated learning server from a client device, model update data, wherein the model update data is based on a local objective function used by the client device and including a modification configured to increase quantization robustness at the client device; and updating, by the federated learning server, a global model, based on the model update data.

Clause 16: The method of Clause 15, further comprising sending to the client device a set of bit-widths configured to be randomly sampled during training at the client device.

Clause 17: A processing system, comprising: a memory comprising computer-executable instructions; and a processor configured to execute the computer-executable instructions and cause the processing system to perform a method in accordance with any one of Clauses 1-16.

Clause 18: A processing system, comprising means for performing a method in accordance with any one of Clauses 1-16.

Clause 19: A non-transitory computer-readable medium comprising computer-executable instructions that, when executed by a processor of a processing system, cause the processing system to perform a method in accordance with any one of Clauses 1-16.

Clause 20: A computer program product embodied on a computer-readable storage medium comprising code for performing a method in accordance with any one of Clauses 1-16.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for performing federated learning of a machine learning model at a client device, comprising:
receiving, at the client device, a model from a federated learning server;
training, at the client device, the model using a local objective function, wherein the local objective function includes a modification configured to increase quantization robustness at the client device; and
transmitting, from the client device, to the federated learning server an updated model, based on the training.

2. The method of claim 1, further comprising optimizing the model for multiple quantization bit-widths without performing multiple forward-backward passes in a training iteration for each of quantization bit-width.

3. The method of claim 1, wherein the modification comprises a quantization regularization term.

4. The method of claim 3, wherein training the model using the local objective function comprises using a kurtosis regularization term.

5. The method of claim 3, wherein the local objective comprises
$${F}_{i}^{*} ( w , {D}_{i} ) = {E}_{ξ \sim Di} [ {f}_{i} ( w , ξ ) ] + {L}_{KURE} ( w ) ,$$
and L_{KURE}(w) is the kurtosis regularization term.

6. The method of claim 1, wherein the modification comprises a quantizer function configured to quantize weights of the model to a target bit-width.

7. The method of claim 6, wherein training the model using the local objective function comprises estimating a gradient of a quantization rounding operator using straight through estimator approximation.

8. The method of claim 6, wherein the local objective comprises
$${F}_{i}^{*} ( w , {D}_{i} ) = {E}_{ξ \sim Di} [ {f}_{i} ( Q ( w , b ) , ξ ) ] .$$

9. The method of claim 1, wherein the modification comprises a pseudo-quantizer function configured to quantize weights and/or activations of the model to a target bit-width by adding pseudo-quantization noise sampled from a distribution associated with a quantization step-size.

10. The method of claim 9, wherein the distribution is a uniform distribution parametrized in part by a specified bit-width.

11. The method of claim 1, further comprising determining a bit-width for training the model at the client device from a set of possible bit-widths used by the federated learning server by sampling from a random distribution associated with a quantization step-size.

12. The method of claim 11, wherein the random distribution is a uniform distribution.

13. The method of claim 11, further comprising learning a quantization step size during the training.

14. The method of claim 1, wherein training the model using the local objective function comprises using stochastic gradient decent.

15. A computer-implemented method for performing federated learning of a machine learning model, comprising:
receiving, at a federated learning server from a client device, model update data, wherein the model update data is based on a local objective function used by the client device and including a modification configured to increase quantization robustness at the client device; and
updating, by the federated learning server, a global model, based on the model update data.

16. The method of claim 15, further comprising sending to the client device a set of bit-widths configured to be randomly sampled during training at the client device.

17. A processing system, comprising: a memory comprising computer-executable instructions; and a processor configured to execute the computer-executable instructions and cause the processing system to:
receive, at a client device, a model from a federated learning server;
train, at the client device, the model using a local objective function, wherein the local objective function includes a modification configured to increase quantization robustness at the client device; and
transmit, from the client device, to the federated learning server an updated model, based on the training.

18. The processing system of claim 17, wherein the processor is further configured to execute the computer-executable instructions and cause the processing system to optimize the model for multiple quantization bit-widths without performing multiple forward-backward passes in a training iteration for each of quantization bit-width.

19. The processing system of claim 17, wherein the modification comprises a quantization regularization term.

20. The processing system of claim 19, wherein training the model using the local objective function comprises using a kurtosis regularization term.

21. The processing system of claim 19, wherein the local objective comprises
$${F}_{i}^{*} ( w , {D}_{i} ) = {E}_{ξ \sim Di} [ {f}_{i} ( w , ξ ) ] + {L}_{KURE} ( w ) ,$$
wherein L_{KURE}(w) is the kurtosis regularization term.

22. The processing system of claim 17, wherein the modification comprises a quantizer function configured to quantize weights of the model to a target bit-width.

23. The processing system of claim 22, wherein training the model using the local objective function comprises estimating a gradient of a quantization rounding operator using straight through estimator approximation.

24. The processing system of claim 22, wherein the local objective comprises
$${F}_{i}^{*} ( w , {D}_{i} ) = {E}_{ξ \sim Di} [ {f}_{i} ( Q ( w , b ) , ξ ) ] .$$

25. The processing system of claim 17, wherein:
the modification comprises a pseudo-quantizer function configured to quantize weights and/or activations of the model to a target bit-width by adding pseudo-quantization noise sampled from a distribution associated with a quantization step-size; and
the distribution is a uniform distribution parametrized in part by a specified bit-width.

26. The processing system of claim 17, wherein the processor is further configured to execute the computer-executable instructions and cause the processing system to determine a bit-width for training the model at the client device from a set of possible bit-widths used by the federated learning server by sampling from a random distribution associated with a quantization step-size.

27. The processing system of claim 26, wherein the random distribution is a uniform distribution.

28. The processing system of claim 26, wherein the processor is further configured to execute the computer-executable instructions and cause the processing system to learn a quantization step size during the training.

29. The processing system of claim 17, wherein training the model using the local objective function comprises using stochastic gradient decent.

30. A processing system, comprising: a memory comprising computer-executable instructions; and a processor configured to execute the computer-executable instructions and cause the processing system to:
receive, at a federated learning server from a client device, model update data, wherein the model update data is based on a local objective function used by the client device and including a modification configured to increase quantization robustness at the client device; and
update, by the federated learning server, a global model, based on the model update data.
